(19) United States
(12) Patent Application Publication
(10) Pub. No.: US 2007/0057792 A1
(43) Pub. Date: Mar. 15, 2007

(54) Contact arrays and processes for wireless batteryless user input

(76) Inventor: Ray M. Alden, Raleigh, NC (US)

Correspondence Address: Ray M. Alden, 808 Lake Brandon Trail, Raleigh, NC, 27610, US

(21) Appl. No.: 11/482,216

(22) Filed: Jul. 7, 2006

Related U.S. Application Data
(63) Continuation-in-part of application No. 11/224,163, filed on Sep. 12, 2005.
(63) Continuation-in-part of application No. 11/369,491, filed on Mar. 7, 2006.
(60) Provisional application No. 60/759,084, filed on Dec. 12, 2005.

(51) Int. Cl. G08B 13/14

(52) U.S. Cl. 340/572.1

(57) ABSTRACT

The invention described herein represents a significant advancement in systems that enable a user to control systems and input data into a very wide range of systems. User interface devices that comprise an array of input devices such as buttons on a remote control, keys on a computer keyboard, touch screens, and a computer mouse. Such devices comprise an array of contacts that can be used to capture a user's inputs and communicate them wirelessly using passive RFID apparatuses and processes. Contacts can be positioned in physical proximity to graphics or alphanumeric characters and this proximity can be stored in memory such that a user altering a specific contact status represents specific data to a controlled system or memory. Also, the sequence or change or direction of changes in contacts can be used to control systems or processes in predetermined ways. Remote controls, computer keyboards, a computer mouse, touch screens and pads created with the present contact array invention need not use complex circuits and do not require batteries to operate wirelessly.

### PRIOR AND RELATED APPLICATIONS

This application is a Continuation In Part of U.S. patent application Ser. No. 11/224,163 filed Sep. 12, 2005 and of U.S. Provisional Patent Application No. 60/759,084 filed Dec. 12, 2005 and of U.S. patent application Ser. No. 11/369,491 filed Mar. 7, 2006, and of U.S. patent application Ser. No. 11/376,799 filed Mar. 16, 2006.

### BACKGROUND FIELD OF INVENTION

The field of invention relates to systems for enabling a user to input information used to control processes and to create data. More specifically a system using a plurality of contacts in array in electrical communication with an RFID transponder operating as a batteryless and wireless user input device and optionally combined with a data display means. The present invention combining touch based contact arrays with proximate alphanumeric character indicia and a passive RFID transponder to provide a batteryless and wireless user input device having many objects and advantages.

### BACKGROUND-DESCRIPTION OF PRIOR INVENTION

Arrays of contacts in the prior art commonly are used as touch type input devices such as key pads and keyboards. Passive RFID transponders in the prior art are commonly used in logistics systems whereby a reader sends a RF signal which is received by a passive transponder which converts the received radio signal into and electric current which is used to power a responding signal from the transponder to the reader. The transponder's responding signal comprising a modulation that communicates unique identification information generally without real-time human interaction. The present invention combines arrays of contacts often with proximate indicia and with an RFID transponder to create wireless user input devices that require no batteries to operate offering multiple and significant objects and advantages. The present invention can add an optional display where the user inputs information on the wireless input device, the reader receives the user input, a connected processor interprets the user input, the reader sends the interpreted user input to a display (such as a bi-stable wireless and batteryless display) so the user can confirm that the interpreted data accurately reflects the user input or that intended processes are executed.

### BRIEF SUMMARY

The present invention combines arrays of contacts with proximate indicia and with an RFID transponder to create wireless user input devices that require no batteries to operate offering multiple and significant objects and advantages. An optional display is added whereby data or instructions initiated by the user input are displayed upon the display with the user input and the display out put both passing through an RFID reader thus ensuring accuracy of interpretation of user input and instructions. Thus the present invention offers a significant advancement in the ability to communicate an unlimited range of information in a multiform low cost wireless interface without complex integration problems and without need for batteries.

Objects and Advantages

Accordingly, several objects and advantages of the present invention are apparent. It is an object of the present invention to provide a means to reliably and inexpensively communicate a very wide range information using an RFID technique. It is an object of the present invention to provide a means to reliably and inexpensively communicate a very wide range information using a wireless technique.

It is an advantage that a user can communicate information wirelessly and without batteries.

It is an advantage of the present invention that user keyed entries can be converted to data autonomously.

It is an advantage of the present invention that it can utilize nearly any wireless method such as an RFID transponder chip, circuit, and antenna that is known in the prior art.

It is an advantage of the present invention that it can utilize nearly any reader that is known in the RFID industry.

It is an advantage of the present invention that it can utilize many reading approaches or protocols such as ALOHA, tree walking or binary tree, FDMA, and CDMA.

It is an object of the present invention to create a data input and communication means for a wide range or uses. It is an advantage of the present invention to eliminate the need for batteries in wireless devices. It is an advantage of some embodiments that they are completely solid state with no moving parts. It is an advantage of the present invention that complex integration of circuits together is not required. It is an advantage that something as simple as a sheet of paper with contacts printed thereon and connected to an inexpensive RFID transponder circuit can be used as a data input device replacing something as complicated as a computer keyboard for example. It is an object of the present invention that it can take the form of a stick on sheet that can be suck nearly anywhere one desires a wireless user input keypad or system control device. It is an advantage of the present invention that it can be integrated with a display output system such that user inputs can be confirmed wirelessly and batterylessly on an inexpensive bistable display.

Further objects and advantages will become apparent from the enclosed figures and specifications.

### DRAWING FIGURES

FIG. 1 illustrates a touch type user input device circuit.

FIG. 2a illustrates an RFID transponder or tag formed by a simple circuit integrated with an alternate user input device 401b.

FIG. 2b illustrates an RFID transponder or tag formed by a circuit architecture common to Texas Instruments RFID devices integrated with the user input device of FIGS. 1, 3, 4, 5, 6, 7, 8, 9, 10, 11a, 11b, or 12f.

FIG. 3 illustrates a contact array similar to FIG. 1 and with the RFID transponder circuit such as FIG. 2a or 2b integrated therein for operation as a user input device for inputting data and wirelessly controlling systems and processes.

FIG. 4 illustrates the contact array of FIG. 3 being operated by a user.

FIG. 5 illustrates the contact array of FIGS. 3 and 4 being further operated by a user.

FIG. 6 is a flowchart describing a range of process steps for creation and user operation of contact array based user interfaces for inputting data and wirelessly controlling systems and processes using an RFID transponder.

FIG. 7 illustrates a process flow chart comprising the steps that may comprise aspects of the present invention such as fabrication of a RFID enabled user alterable wireless batteryless contact array, its operation for capturing of user inputs, sending of altered RFID signatures, wirelessly interfacing with a reader which senses altered signature outputs, and converting sensed altered signatures, into data and computer instructions, and the displaying of user inputs or computer data in accordance with a user's instructions.

FIG. 8 illustrates an RFID transponder enabled wireless, battery-less contact array based substrate and mouse user input device for inputting data and controlling systems and processes.

FIG. 9 illustrates an RFID controlled bistable display such as is also described in FIGS. 3, 4, 5, 7, 8, and 10.

FIG. 10 illustrates an RFID wireless and batteryless contact array joystick user input device of the present invention.

FIG. 11a illustrates a magnetically actuated contact array substrate in default open contact state.

FIG. 11b illustrates a magnetically actuated contact array substrate in default closed contact state.

FIG. 12a depicts a paper substrate 401e having an upper surface and a bottom surface.

In this step, a paper substrate is provided.

FIG. 12b depicts a step of printing alphanumeric characters on the upper surface of the paper substrate including a first printed character 601 and a second printed character 603.

FIG. 12c depicts the printing or deposition of a first conducting row 605 onto the upper surface of the paper substrate and over at least a portion of some of the printed characters or in close proximity to the printed characters.

FIG. 12d depicts a second layer printing or depositing a first insulating column 607 which also is deposited on the first printed character and a second insulating column 609 which also is deposited on the second character.

FIG. 12e depicts the last fabrication step where conductive columns are printed or deposited on top of respective insulated columns including a first conductive column atop insulator 611 and a second first conductive column atop insulator 613.

In FIG. 12f a user's finger 53e or another means can be used to close a circuit between a column and a row to capture user input of alphanumeric characters such as the number “4” which has been selected by a user.

FIG. 13a illustrates a key architecture for generating a current each time a user depresses a key.

FIG. 13b is an alternate current generator at the key level.

FIG. 13c illustrates a key pad architecture where multiple keys share a single key stroke based current generating means in a non-depressed state.

FIG. 13d is the key pad of FIG. 13c with one key in the depressed state.

### DETAILED DESCRIPTION OF THE INVENTION

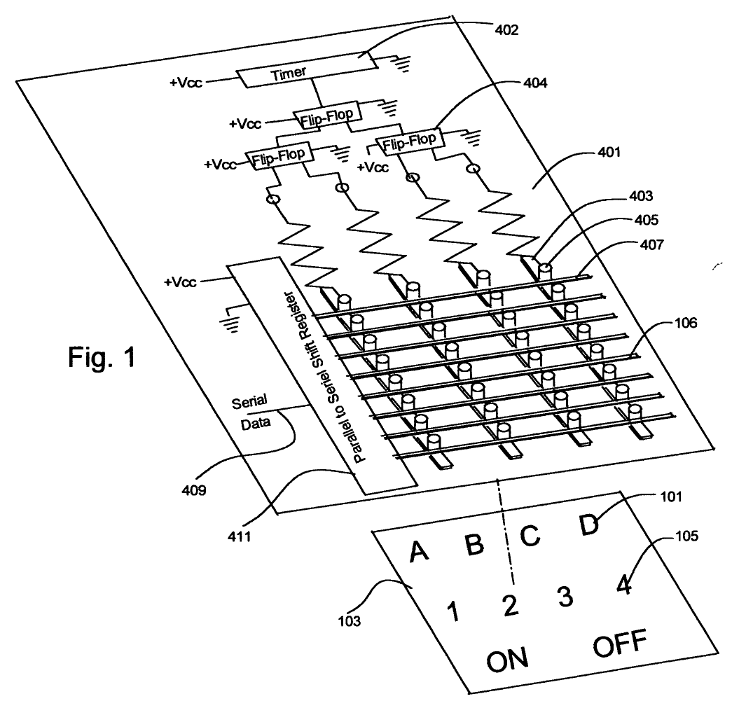

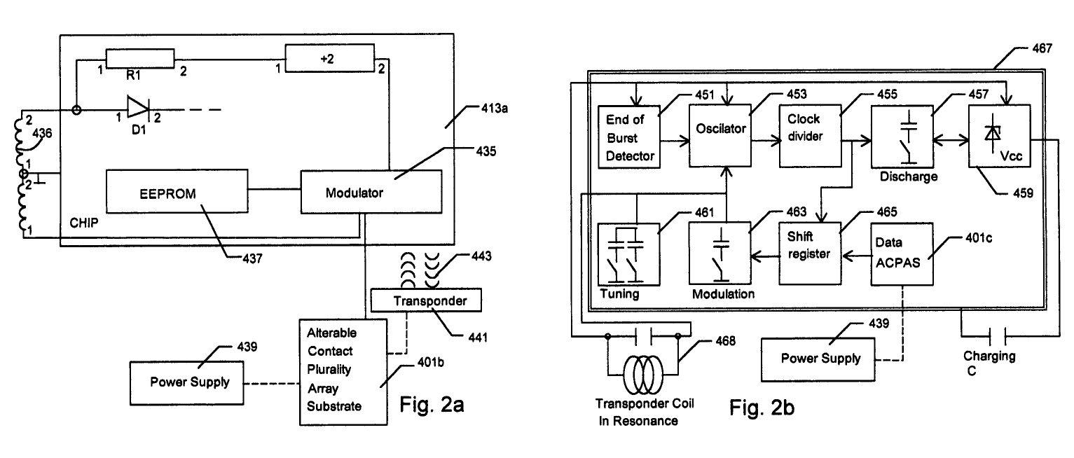

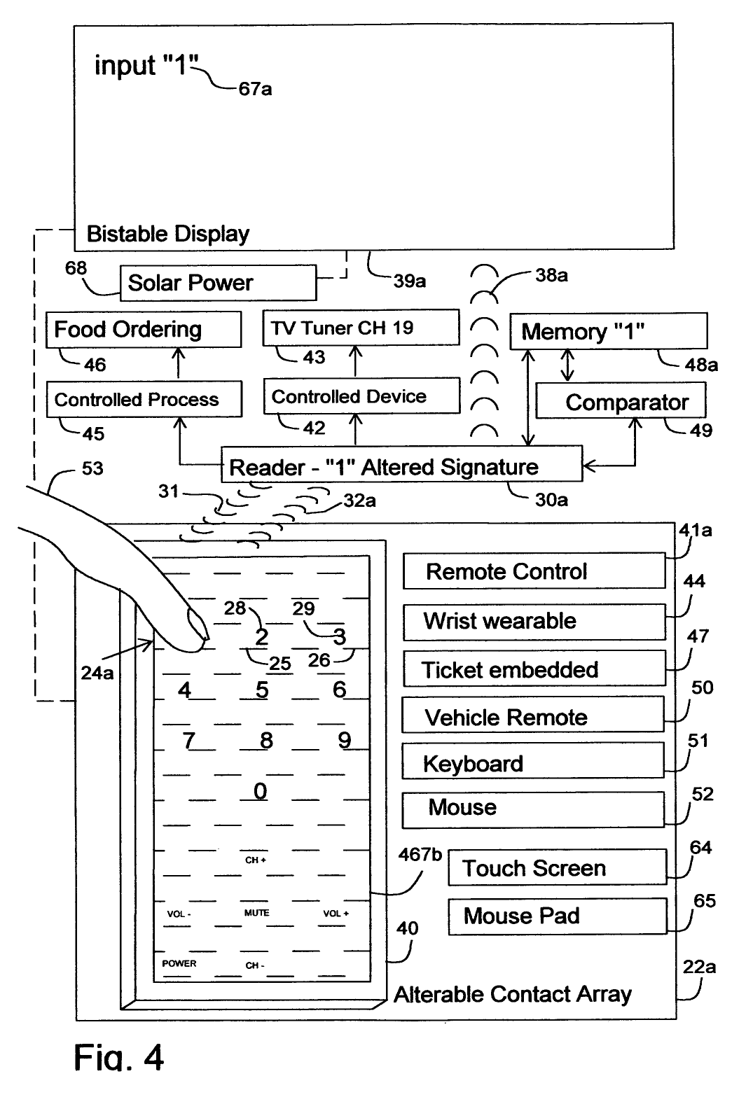

FIG. 1 illustrates a touch type user input device circuit. A user input device 401 comprises a plurality of open circuit connections comprising two sides of a circuit including a plurality of columns of raised contact points such as a first raised contact point 405 that is one of a column of raised contact points in communication with a column 403 which is on a first side of the circuit addressable by a flip-flop array including a first flip-flop 404 through an iterative process controlled by a pulse timer 402 the first flip-flop 404 together with the operation of the timer and other flip-flops alternates between a state of directing an electric current to the column 403 and a state of not directing an electric current to the column 403. The first raised contact point being one of a plurality of similar raised contact points connected to the column 403 each raised contact point which are arrayed to be physically isolated from one another by a non-conductive space and to be electronically isolated from the second side of the circuit except when a user makes an input using the column according to processes described in FIGS. 4, 5, 6, 7, 8, 9, 10, 11a, 11b, and 12f. On the second side of the circuit is a first raised contact line 407 which is one of a plurality of similar raised contact lines in array. The raised contact lines are electrically isolated from one another and from the raised contact points except when connected by a user making an input using the column according to processes described in FIGS. 4, 5, 6, 7, 8, 9, 10, 11a, 11b, and 12f. The raised contact lines are in electrical communication with a serial shift register 411 which in operation comprises a serial data stream output 409 signal comprising a first signature state when no user input is made and a second signature state when user input is made said signal being transmitted according to known RFID processes, protocols, and hardware such as is described in FIGS. 2a, 2b, 3, 4, 5, 6, 7, and 9. When fabricated, the user input device 401 is integrated with a substrate (not shown) such as a paper product that has an upper surface nearly equal to the height of the raised contact points and raised contact lines and which fills the voids between the contact points and contact lies to comprise a surface comprising areas having contacts and areas having no contacts. The resulting fabrication being a substrate that can have indicia such as alphanumeric characters printed thereon or if fabricated of transparent plastic an indicia sticker 103 can be adhered to the bottom surface. In either case, where the substrate is to be used as a user keypad or keyboard input device, a first alphanumeric character 101 and a second alphanumeric character 105 are positioned relative to predetermined open contacts on the substrate such that when a user physically touches the first alphanumeric character 101, a first contact is closed thereby completing a first part of the formerly open circuit which causes a first altered serial data pattern to be output and when a user physically touches the second alphanumeric character 105, a second contact is closed thereby completing a second part of the formerly open circuit which causes a second altered serial data pattern to be output. Prior to operation, the first altered serial data pattern and the second altered serial data pattern being stored in a memory together with respective associated alphanumeric meanings and/or alphanumeric images such that when those data patterns are received, a processor can assign them meaning according to their definitions in memory. Thus when the signal pattern associated with the contacts closest to the first alphanumeric character are sensed by a reader as later discussed, a processor assigns them a meaning of “D” from memory and when the signal pattern associated with the contacts closest to the second alphanumeric character are sensed by a reader as later discussed, a processor assigns them a meaning of “4” from memory from. A sequence of alternated serial data patterns transmitted wirelessly representing a sequence of user inputs similar in operation and meaning to a very wide range of devices having keyboards or keypads but in the present invention operated wirelessly according to RFID or other processes (such as SAW for example) not requiring batteries. The substrate operating wirelessly according to known RFID modulation techniques whereby the serial data output 409 is used to modulate the signal in a passive RFID transponder such as those of FIG. 2a or 2b and many other transponders of the prior art capable of electronically connecting to the serial data output 409 and modulating an output signal which can be wirelessly received by an RFID reader.

An example of the correlation between user inputs, serial outputs, and modulation pattern can be as follows. The art of FIG. 1 receives depicted voltage from a battery, solar cell, a user powered current generation means, or from at least one RFID powered induction coil. The flip-flops send an electrical current to the first column, the shift register checks the first row for a charge, if a user key stroke is present, a contact is made and an electric charge is present yielding a binary “1” output which causes a first signal modulation state, if no user key stroke is present, a contact is not made and an electric charge is not present yielding a binary “0” output which causes a second signal modulation state. The flip-flops continue to send an electrical current to the first column, until the shift register similarly checks all rows for a charge including a second row 106, if a user key stroke is present, a contact is made and an electric charge is present yielding a binary “1” output, if no user key stroke is present, a contact is not made and an electric charge is not present yielding a binary “0” output. Once all of the first column contacts are checked, the flip-flops, in conjunction with the timer, switch to sending an electrical current to the second column and subsequently all respective additional columns so the shift register can check each of them for contacts that have been created by user input. This iterative process serially checks each prospective column/row contact coordinate for a user input and reports the status of each in a serial data stream which is reported wirelessly via a modulated signal.

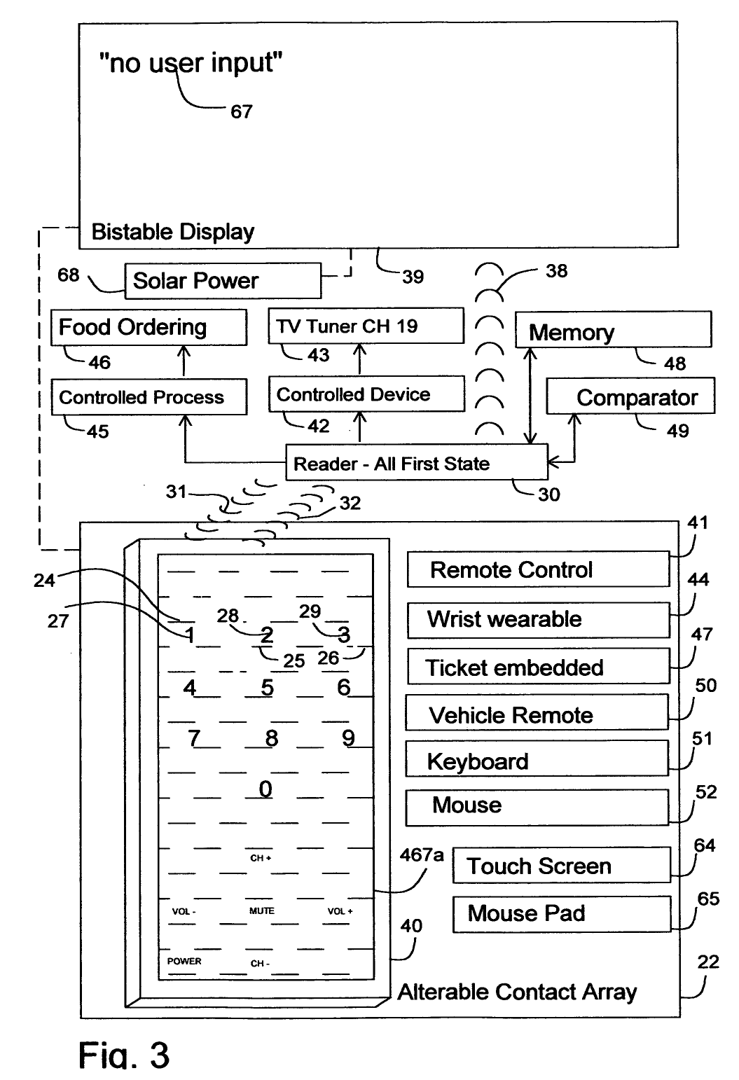

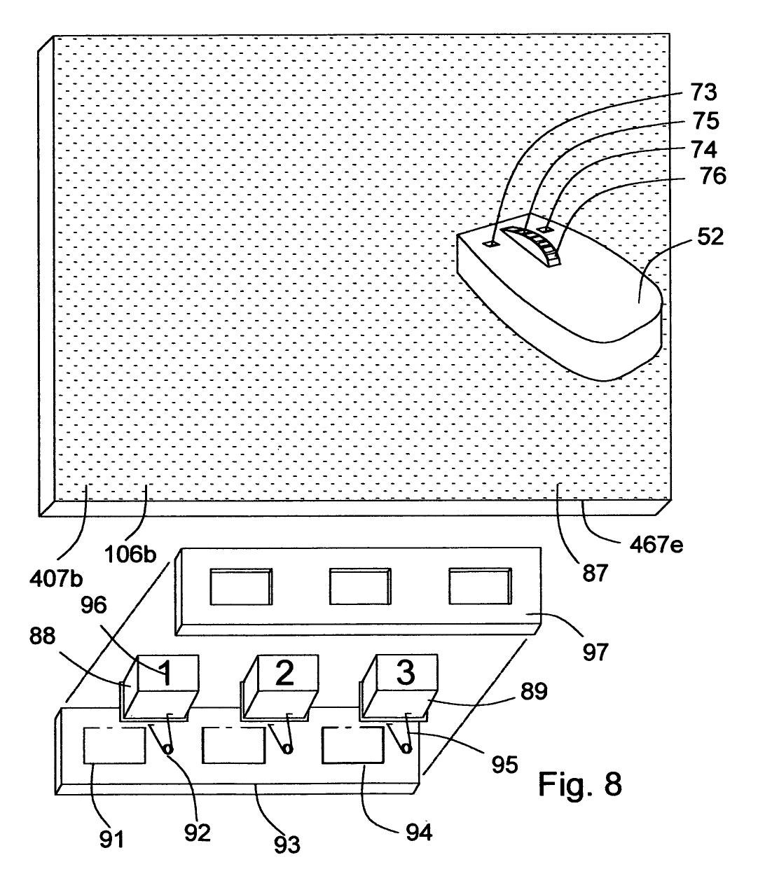

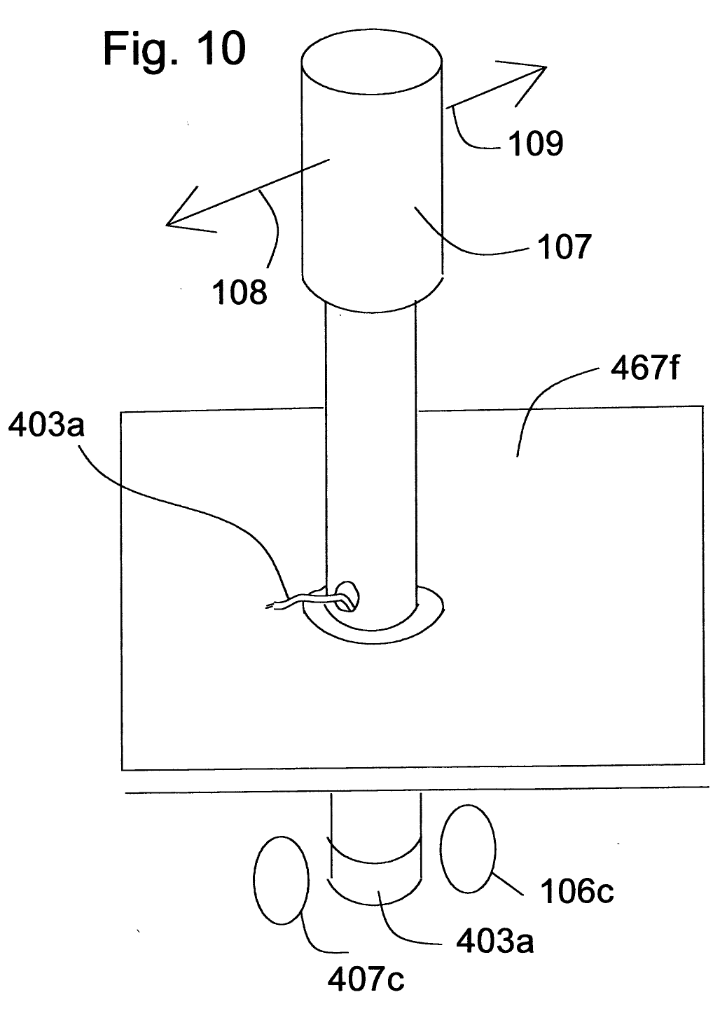

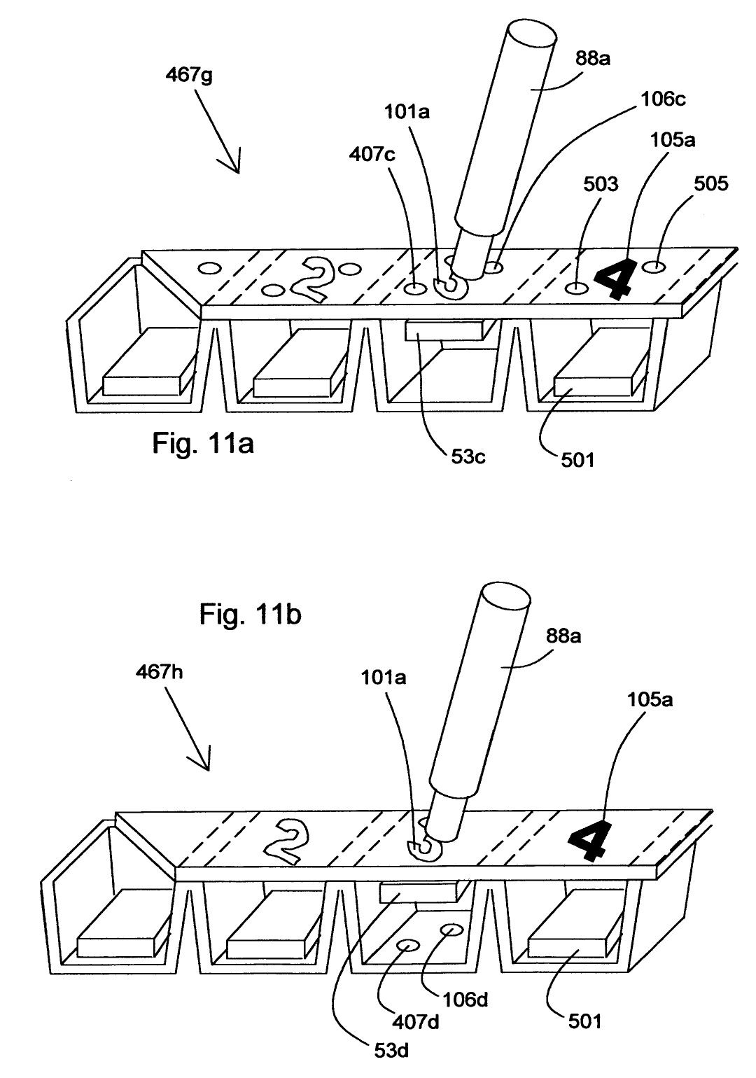

The user input device 401 is integrated with a tag or transponder according to FIG. 2a or 2b to enable a circuit that can receive user input through key strokes as in FIGS. 1, 2a, 2b, 3, 4, 5, 6, 7, 8, 9, 10, 11a, 11a, and 12f whereby user input comprises completion of connections between raised contact points and raised contact lines (or the contact points of FIG. 10, 11a, 11b, or 12f). Prior to receiving any user input, the user input device 401 produces a serial output which is wirelessly transmitted, received and read as all “0's” since no contacts between raised contact points and raised contact lines have been made. As a user makes inputs upon the substrate and thereby connects selected raised contact points to raised contact lines, the user input device 401 is read as a serial combination of “0's” where no connections have been made and “1's” where connections have been made and these 1's and 0's are a proxy indicator describing what alphanumeric inputs the user is inputting via the substrate and they are transmitted through the FIG. 2a or 2b RFID architecture according to FIGS. 3, 4, 5, 6, 7, 9, 10, 11a, 11b, and 12f and selectively converted to data and to drive processes described therein. The user input device 401 can be scaled to be nearly any size and any resolution using well known principles and available electronic circuitry, the version described in FIG. 8 being significantly larger and having a higher resolution (number of raised contact points per inch) than that of FIG. 1. Also, while the user input device 401 version depicted in FIG. 1 begins with all contacts open, it could just as well begin with all contacts closed and whereby the user's input is captured by opening respective contacts such as is the case with FIG. 11b.

As in the prior patent applications of the present applicant which are incorporated herein and of which this application is a continuation in part, the art of FIG. 1 and of FIG. 8 can be transparent and used in front of a printed substrate or used in front of a display screen to capture user input which is associated with images displayed on the printed substrate or on the display screen.

Also the art of FIG. 1 need not be associated with alphanumeric characters. For example, FIG. 8 illustrates a larger, higher resolution substrate similar to that of FIG. 1. The substrate of FIG. 8 is used to track user input through the positional or sequential change of contacts such as are created by the moving of a mouse on the substrate as a means to change the status of contact points and thereby capture user input which is then read out using wireless passive RFID processes such as those described in FIG. 1 and ensuing Figures. Similarly, the contact array of FIG. 1 can be formatted in a three dimensional manner such as FIG. 10 whereby a joy stick comprises an array of contacts that can be opened or closed by a user as a means to capture user input which is then read out using wireless passive RFID processes such as those described in FIG. 1 and ensuing Figures.

The above elements of FIG. 1 can be identical to those described by the present applicant in FIG. 10 of application Ser. No. 11/224,163 which is incorporated herein by reference.

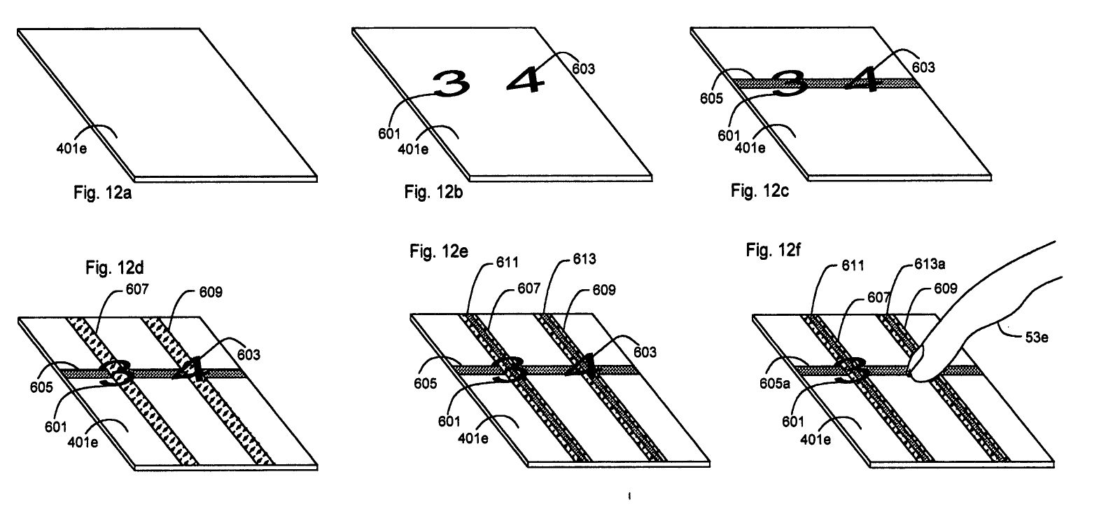

The art of FIG. 1 can be utilized together with alphanumeric characters such as with a key pad or keyboard embodiment of FIG. 3. The art of FIG. 1 can be used with the sequence of motion detection and reporting embodiment such as in FIG. 8. The art of FIG. 1 can be used in the detection and reporting of tilt positions such as in the joystick embodiment of FIG. 10. The art of FIG. 1 can be used in the magnetic contact arrays of FIG. 11a and 11b. FIGS. 12a through 12f illustrate and alternate contact array fabrication methodology that can replace the contact array and be integrated with the other elements of FIGS. 1, 2a, and 2b.

FIG. 2a illustrates an RFID transponder or tag formed by a simple circuit integrated with an alternate user input device 401b. The alternate user input device 401b comprises a device capable of capturing user input and outputting serial data according to FIGS. 1, 3, 4, 5, 6, 7, 8, 9, 10, 11a, 11b, and 12f and which is integrated with a transponder circuit 413a of the prior art comprising a modulator 435 which is utilized to modulate an output wireless signature as a means to report the status of each respective raised contact point of FIG. 1 in a predetermined order so as to represent user input which can be converted to alphanumeric input or positional or sequence data by comparing the wireless signature to signatures in memory and meanings in memory associated therewith. The modulator 435 receives the serial data output 409 of FIG. 1 and modulates a wireless signal according to user inputs as described in FIGS. 1, 3, 4, 5, 6, 7, 8, 9, 10, 11a, 11b, and 12f. An erasable memory 437 may be in the circuit to communicate unique identifier information common to RFID practice but this need not be the case. In a passive or batteryless embodiment an induction coil 436 is used to capture energy from an RFID reader to power the system according to known RFID processes however in an active embodiment a separate power supply 439 may be provided depending upon the size, energy requirements, and other characteristics of the alternate user input device 401b. In an alternate approach, an intermediary integrated transponder 441 may transmit an intermediary integrated transponder signal 443 in lieu of a direct connection to the simple integrated transponder circuit 413a. Having intermediary transponders is possible similarly to transponder networks known in the prior art. While FIGS. 1 and 2a show the user input devices being distinct from the RFID transponder in practice, these devices will most often be integrated together to form a single device for capturing user inputs and transmitting them according to known RFID processes. The art of FIGS. 1, 3, 4, 5, 6, 7, 8, 9, 10, 1a, 11b, and 12f can be physically and electronically integrated into the art of FIG. 2a.

FIG. 2b illustrates an RFID transponder or tag formed by a circuit architecture common to Texas Instruments RFID devices integrated with the user input device of FIGS. 1, 3, 4, 5, 6, 7, 8, 9, 10, 11a, 11b, or 12f. A Texas Instruments user input device enhanced transponder 467 comprises the circuitry and processes to power and accept serial data output from a user input device and effectively modulate a corresponding readable signal as a transponder which communicates user inputs wirelessly according to known RFID processes. The transponder operational process flow may comprise steps including an end of burst 451 being sensed which causes an oscillator 453 to initiate a clock driver 455 to begin a modulation 463 according to output from an alternate shift register 465 which facilitates the readout of data from a second alternate user input device 401c (alterable contact plurality array substrate such as FIG. 1 or FIG. 12f). A tuner 461 facilitates the oscillation with the transceiver or RFID reader (not shown). A discharge step 457 is provided to ensure the transponder is properly prepared for initiating a communication session with the transceiver. A voltage regulator 459 is in connection with a transponder coil 468 which is modulated to report the digital data from the second alternate user input device 401c. The transponder coil 468 provides induced power for the circuit for passive operation and communicates the modulated signal to the reader. The transponder coil 468 may be as large as the FIG. 1 substrate itself so as to optimize the amount of energy it can collect and the distance at which it can be read by the reader. An augmented power supply 439 may be provided if needed. The art of FIGS. 1, 3, 4, 5, 6, 7, 8, 9, 10, 11a, 11b and 12f can be physically and electronically integrated into the art of FIG. 2b.

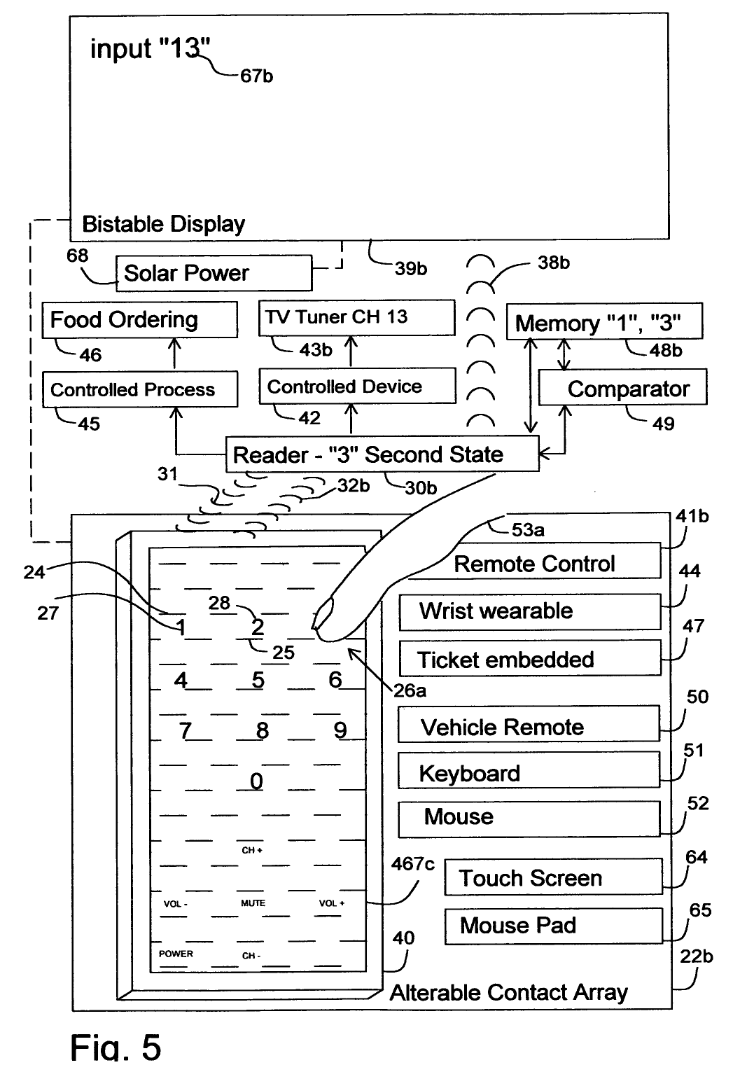

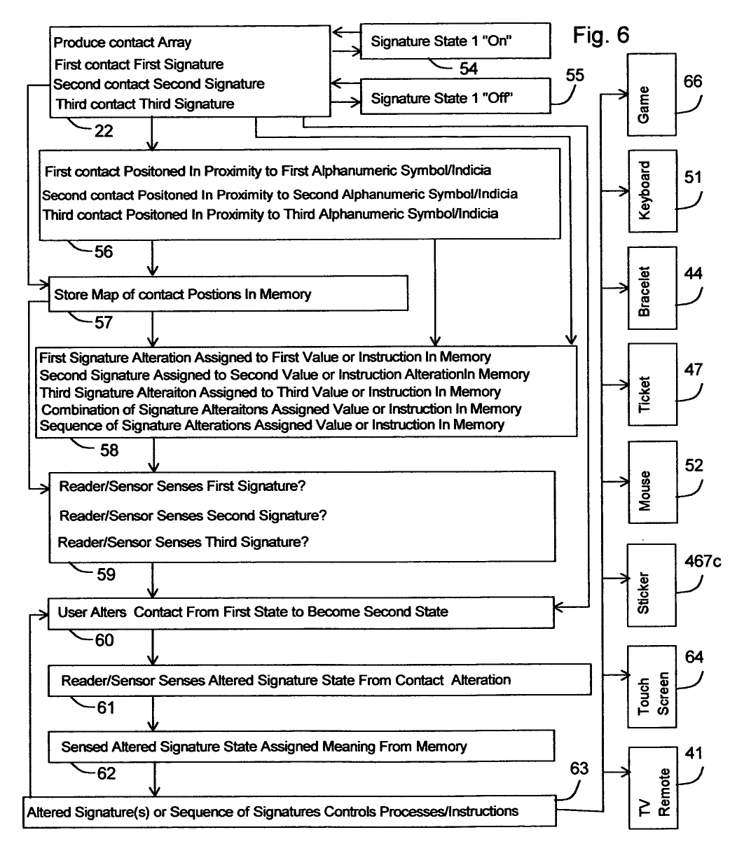

FIG. 3 illustrates a contact array similar to FIG. 1 and with the RFID transponder circuit such as FIG. 2a or 2b integrated therein for operation as a user input device for inputting data and wirelessly controlling systems and processes. A wireless readable contact array 22 is a device that enables a user to input data and control systems and processes. It can take many forms and interface with many applications some of which are listed in FIG. 3 and in FIG. 6 and which are further described herein. An adhere-able substrate 467a comprises a substrate comprising a first surface having an array of contacts similar to those described in FIGS. 1 or 12f in proximity to alphanumeric characters printed thereon and the substrate having a second surface with adherent applied thereto such that it can be adhered to a mounting position virtually on any product or in any location where one desires a user input device. The thus adhere-able or sticker substrate being glued to a rigid substrate 40 that can be a piece of plastic or even wood such that it is comfortable for a user to hold but which is devoid of internal electrical components and batteries common in prior art devices because the only components needed for the device of FIG. 3 to operate are the array of contacts and electronics of FIG. 1 in conjunction with an RFID transponder such as in FIG. 2a, or 2b. In its essence, the wireless readable contact array 22 comprises a plurality of open contacts each of which can be caused by a user to switch between at least two digital readout states including a first contact state that can be read by RFID processes as a first modulated signal which is previously stored in a memory and is representative of a first open contact state and a second contact state that can be read by RFID processes as a second modulated signal which is stored in a memory and is representative of a second closed contact state. As described in FIG. 1 and throughout this application, a user is able to input data, and control processes and systems by selectively switching contacts on the substrate between their respective first open contact state and their respective second closed contact state in a user directed process where each contact state change can be detected remotely through changes in a digital signal or wireless signature output that are read by an RFID reader which in-turn is in communication with systems and processes over which the user desires to exercise control. The RFID reader and connected processes utilize user directed contact state changes in individual contacts as in FIGS. 1, 4 and 5, the combination of contact state changes in a plurality of contacts as in FIGS. 5 and 8, and a sequence of contact state changes in a plurality of contacts as in FIG. 8 each according to predetermined logic and patterns defined in memory as the means to interpret a user's input. A contact array for the purposes of this document is a plurality of contacts each of which a user can selectively switch between a first state and a second state as a means for inputting data or controlling processes. A first contact point 24 is one of an array of contact points that have been fabricated to be on the first surface of the adhere-able substrate 467a. According to FIG. 1 or FIG. 12f the contacts are fabricated and positioned such that a user's finger can become in electrical communication with the contact to alter its state from open to closed or vice versa thereby, a user can cause a connected transponder's wireless RFID signal modulation state to switch from a first modulation output to a second modulation output according to FIGS. 1, 2a, and 2b. The difference between a contact's first output signature state and second output signature state can comprise a difference in readability (can it be read or not), intensity, frequency, wavelength, or modulation pattern. A second contact point 25 is identical to the first contact point except it is distinctly positioned away from the first by a void space where no electric contacts are present between contact points and as it is read out as part of the serial data output of FIG. 1, its temporal position in the serial dialog is distinct from that of the first contact point such that a processor in communication with the reader that receives the signal from the transponder can differentiate from the open or closed status of the first contact point and the open or closed status of the second contact point. A third contact point 26 is identical to the second contact point and it is distinct in the same ways that distinguish the first and second contact points. Thus a first wireless RFID signature modulation pattern 32, according to FIG. 3 comprises no user altered contact states and therefore no user input. Similarly, a plurality in array of additional contacts are distinctly positioned with space between each and each being capable of producing a unique change in the associated transponder's RFID signature modulation pattern output that denotes each's respective first contact state such as open compared to its second contact state such as closed.

In one widely useful embodiment, contacts can be positioned in predetermined proximity to alphanumeric characters or other indicia or graphical information to facilitate the ability of a user to input data, control processes, or control systems. In such embodiments, the change of a contact from its first state signature to its second state signature corresponds to a user selecting the alphanumeric character or other indicia as is describe in FIGS. 1, 4, 5, 6, 7, 8, 11a, 11b, and 12f. A first indicia 27 is printed in physical proximity to the first contact point, a second indicia 28 is printed in physical proximity to the second contact point, and a third indicia 29 is printed in physical proximity to the third contact point. In practice, the indicia may be printed upon the adhere-able substrate first and then the contacts printed thereon as in FIG. 12f or vice versa. A reader with first reading 30 is an ordinary RFID reader that is capable of communicating an RFID signal to and receiving an RFID signal back from passive RFID transponders by construction and processes well known in the prior art. As is also common in the prior art, the RFID reader is integrated with additional systems, processors, comparators, logic, memory, computers and databases such that information it reads can be stored in memory, compared to information stored in memory, and be used to control systems and processes. The reader with first reading 30 emits a reader wireless output signal 31 which is received by the contact array substrate and is collected by the at least one transponder coil or antenna such as in FIG. 2a and 2b to provide the energy for checking each of the contact states according to FIG. 1 and to power the transponder to respond with a modulated wireless signal or signature describing the serial data output 409 for FIG. 1 according to RFID communication protocols known in the prior art. Each contact point depicted in FIG. 3 starts in a first open contact state such that the first wireless RFID signature modulation pattern 32, comprises a modulation pattern of all “0's” denoting no user input, this modulation pattern is received by the reader with first reading 30, and compared by a comparator 49 to values in a memory 48. The memory 48 contains a list of all of the respective modulation patterns associated with each contact point in the array and the associated character meaning that they respectively convey according to FIGS. 1, 3, 4, 5, 6, 7, 8, 11a, 11b, and 12f. In the embodiments described in FIG. 8, the memory may also contain a map of the physical positions of each of the contact points in array. The map is especially useful in the mouse, touch screen, and touch pad (or mouse pad) embodiments since the sequence in which the contact point connection states are altered by the user's actions is used to determine the physical position of a curser or arrow on a computer screen. In the condition described in FIG. 3 where no user input is detected, the reader 30 may send a signal to a display 39 in a no user input status 67 embodiment of FIGS. 1, 2, and 3, the fact that first state modulation pattern is received from the transponder indicates the user has not made any selections, pressed any keys, or otherwise altered and contacts from their first state of open to their second state of closed.

Note that the RFID writable display in combination with the RFID readable user keyed input as a means to confirm the user's input is a novel combination that was disclosed in FIGS. 1 and 2 of patent application Ser. No. 11/376,799 of which this application is a continuation in part and which is incorporated herein by reference. In FIGS. 3, 4, 5, dotted line between the wireless readable contact array 22 the display 39 indicates that they can be completely electronically distinct from each other while at the same time, they can be physically connected to one another. An example of a device that incorporates an input device and display in this manner would be a “dumb laptop” for use in distributed computing applications. In contrast to a standard laptop, a dumb laptop requires no standard computer CPU and no standard computer memory. In fact the dumb laptop can comprise two pieces of plastic which are jointed to be foldable or collapsible like a standard laptop but which have literally no components inside. Affixed to one surface of the foldable plastic is a stick on keyboard sticker and affixed to another surface of the foldable plastic is a stick on display sticker. Thus the dumb laptop is far cheaper than a traditional laptop that has a dense cluster of complex electronics inside. The operational process of this dumb laptop is also different from a regular laptop. As described herein, a user keys information onto a dumb laptop which is sent using RFID, an RFID reader senses the users key strokes as described herein, a processor in electronic commutation with the reader interprets the users keystrokes and uses them to control processes and create data in memory, all of the traditional computer processes are done in systems connected to the reader and none of the traditional computer processes are done by the dumb laptop with no electronics inside except for the user key board/mouse pad interface and display output user interface. A processor connected to the reader sends output from the computer processes to the reader which relays it via RFID to the display on the dumb laptop. Thus the display on the dumb laptop can confirm the user's input such as is described in FIGS. 3, 4, and 5, and also the display on the dumb laptop can describe the position of a curser controlled by a mouse as in FIG. 8. The RFID reader signals to display 38 contain instructions to control power to individual pixels comprising the display such as from a solar power source 68 or from an RFID inductance coil. Alternately, the display pixels can be both powered and controlled according to the description in patent application Ser. No. 11/376,799 or it can be a wireless bistable display available from known suppliers such as E Ink, Kodak, SiPix, NTERN, ZBD, Nemoptic, Kent Displays, or others. The dumb laptop display can display data called up by the user or display the status of processes initiated by the user. In a distributed computed model where the computing power, memory, and applications reside remotely from the user interface device, many batteryless and wireless dumb laptops can all be used concurrently by different users each using the computing resources of one single remote computer system all through wireless RFID based communication processes, software, and devices described herein.

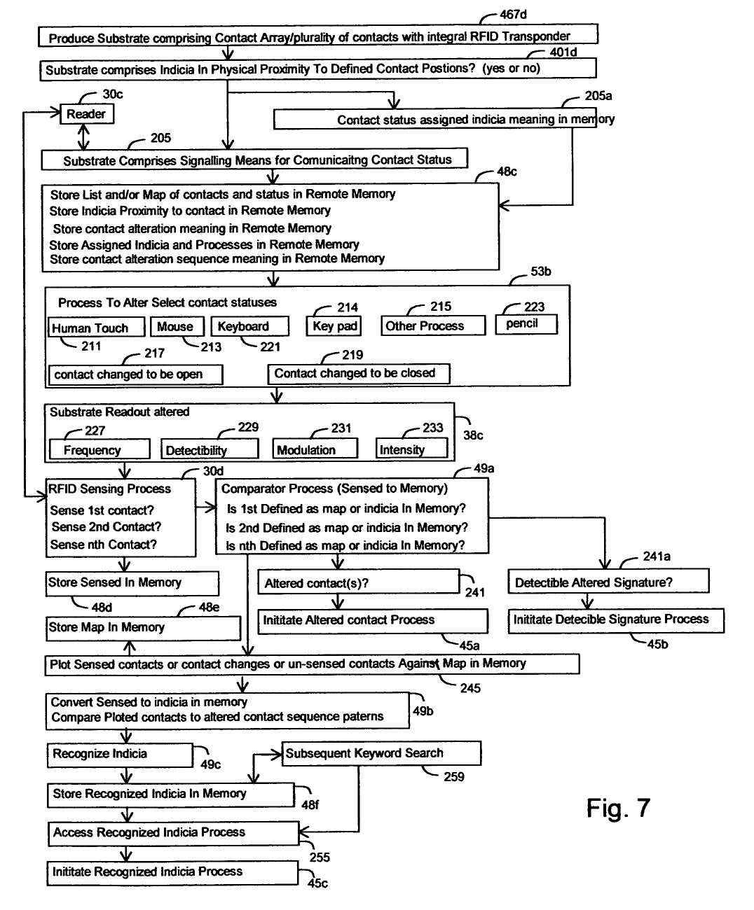

It is understood that in fabrication, the contact points for FIG. 3 are exposed to be capable of electronic communication when touched by a user and to thereby complete an electronic circuit. Other mechanisms are also possible to either complete or open an electronic circuit at the control of a user as is described in FIGS. 8, 10, 11a, and 11b. The embodiment shown in FIGS. 3 through 5 is directed to controlling a TV and is a television remote control user interface 41 that enables communication to a controlled device 42 such as a TV tuner 43 via the reader 30. It will be understood that many other devices can be similarly operated by a remote control device as taught herein according to user input some example devices include a wrist wearable wireless user interface 44 that a user can wear and through which a user can input information to a controlled process 45 and make selections including from a food ordering process/system 46 for example. Such a wearable transponder array system can be worn by people at amusement parks , hospitals, or airports for example. Similarly, airline flyers can be issued an airline ticket based wireless user interface 47 passenger ticket that makes them both RFID trackable in the airport and enables them to key in important information at checkpoints such as social security numbers for example or to key in food orders at restaurants for example. In the security application, the memory 48 can be used with a comparator 49 to ensure that information the user inputs via the ticket based transponder array checks out according to records in the memory. In the food example, credits can be taken away from an account owned by the ticket holder when they purchase something. Similarly a vehicle access remote control user interface 50 and a computer keyboard wireless user interface 51 can rely upon the art described herein to enable a user to input information to control systems and processes. A mouse wireless user interface 52 can be created according to FIG. 8 to interface with a computer system. As described in patent application Ser. No. 11/369,491 which is incorporated herein in its entirety by reference, also a touch screen user interface on transparent substrate 64 can be created according to FIGS. 5a and 5b of that application, a mouse pad (or touch pad) user interface 65 can be created according to FIG. 7 of that application. A signature for the purposes of this document comprises the ability of a signal to be sensed and signatures can comprise attributes such as; is it readable (can it be read at all), intensity, frequency, wavelength, or modulation pattern. Specifically, this document describes RFID signatures that can be sensed in a first signature state or a second signature state by an RFID reader and where the reader is in communication with a comparator or memory that contains attributes of specific signatures such that those read by the reader can be distinguished from one another and their being sensed, being altered, or not being sensed can be assigned meaning in the memory or a comparator logic process that can assign meaning to the signatures being read, being altered, or as the case may be, not being read by the reader.

FIG. 4 illustrates the contact array of FIG. 3 being operated by a user. A user finger altering first contact state 24a touches exposed elements of a first user altered contact point 24a to establish electrical communication therewith and in so doing causes the contact point to transition from a first state of open to a second state of closed. Thus a first user altered wireless signature state from altered user input device 32a is emitted, it is a second signature output state that differs from the first signature output state 32 of FIG. 3 in at least one attribute regarding either a difference in readability (can it be read at all), intensity, frequency, wavelength, or modulation pattern. Note that the first user altered contact point 24a is the only contact point that the user has altered on a first user altered wireless input device array. In alternate embodiments, the user finger altering contact states can be replaced by a mechanical button such as in the lower portion of FIG. 8 or a stylus such as in the art of FIGS. 11a and 11b. Whether actual touch changes the contact state or another mechanism is used, the output signature from the altered user input device 32a, as a result of the user's interaction/input is changed to become a second signature state that can conform to any one of three conditions in order to be recognized by the reader as a user input. Firstly, a user altered signature state reader 30a can read and recognize the output signature from the altered user input device 32a as a valid signature that had previously been stored in the memory. Secondly, the user altered signature state reading 30a can read and not recognize the output signature from the altered user input device 32a as a valid signature that had previously been stored in the memory. Thirdly, the user altered signature state reading 30a can be not read the output signature from the altered user input device 32a at all (it either comprises a signature outside of the reader's range or no signature at all). In any of these three scenarios, the fact that the output signature has been altered from its first state signature is recognized by the comparator which is frequently checking for altered signal states from the reader indicative of changes in contact states which are in turn indicative of user inputs. When the transponder signal state changes, the comparator in conjunction with the memory determines that the user has input the alphanumeric data associated with the contact(s) that is no longer in the first contact state. The comparator assigns the corresponding value or meaning from memory and stores it as a user selection in memory. Thus the comparator selects the first user input alphanumeric data corresponding with proximate symbol and stores it as a first user input in memory 48a thus the comparator interprets and stores the fact that the reader has detected a first altered signature signal from the contact in close proximity to the “1” alphanumeric character as a “1” user input. The difference between an RFID transponder's first signature state and second signature state can comprise a difference in readability (can it be read at all), intensity, frequency, wavelength, or modulation pattern. In the television control application, a user altered television remote control user interface 41a is created when a user touches the contact point in proximity to an alphanumeric character thus altering the state of the touched contact to the transponder to transition from a first signature state to a second signature state. The altered signature state is used by the comparator which establishes a “1” in memory corresponding to the alphanumeric character closest to the user altered contact point and in accordance with the altered contact point's meaning in memory. The comparator instructs the reader to update the first user input display 39a to show the first user input 67a. An altered RFID reader signal to display 38a is sent by the reader to update the display to communicate visually the user input which has been received and interpreted. The user is able to see the number “1” on the display and therefore knows her input has been properly received by the reader and interpreted by the comparator process in conjunction with values stored in memory. Thus an altered wireless readable contact array 22a has captured via an altered adhere-able substrate 467b and communicated a user's keyed input via wireless and batteryless RFID.

FIG. 5 illustrates the contact array of FIGS. 3 and 4 being further operated by a user. A user finger altering second contact state 53a touches exposed elements of a second user altered contact point 26a to establish electrical communication therewith and in so doing causes the contact point to transition from a first state of open to a second state of closed. Thus a second user altered wireless signature state from second user input device 32b is emitted, it is a third signature output state that differs from the first signature output state of FIG. 3 and the second signature output state of FIG. 4 in at least one attribute regarding either a difference in readability (can it be read at all), intensity, frequency, wavelength, or modulation pattern. Note that the second user altered contact point 26a is the only contact point that the user has altered on a second user altered wireless input device array. In alternate embodiments, the user finger altering contact states can be replaced by a mechanical button such as in the lower portion of FIG. 8 or a stylus such as in the art of FIGS. 11a and 11b. Whether actual touch changes the contact state or another mechanism is used, the output signature from the second altered user input device 32b, as a result of the user's interaction/input is changed to become a third signature state that can conform to any one of three conditions in order to be recognized by the reader as a user input. Firstly, the user altered signature state reader 30b has read and recognized as a valid signature that had previously been stored in the memory (as is the case here). Secondly, the user altered signature state reading 30b can be read by the reader and not recognized as a valid signature that had previously been stored in the memory. Thirdly, the user altered signature state reading 30b can be not be read by the reader at all (it either comprises a signature outside of the reader's range or no signature at all). In any of these three scenarios, the fact that the output signature has been altered from its first state signature is recognized by the comparator which is frequently checking for altered signal states from the reader indicative of changes in contact states which are in turn indicative of user inputs. When the transponder signal state changes, the comparator in conjunction with the memory determines that the user has input the alphanumeric data associated with the contact(s) that is no longer in the first contact state. The comparator assigns the corresponding value or meaning from memory and stores it as a user selection in memory. Thus the comparator selects the second user input alphanumeric data corresponding with proximate symbol and stores it as second user input in memory 48b thus the comparator interprets and stores the fact that the reader has detected a second altered signature signal from the contact in close proximity to the “3” alphanumeric character as a “3” user input. The difference between an RFID transponder's first signature state and third signature state can comprise a difference in readability (can it be read at all), intensity, frequency, wavelength, or modulation pattern. In the television control application, a subsequent user altered television remote control user interface 41b is created when a user touches the contact point in proximity to an alphanumeric character thus altering the state of the touched contact to the transponder to transition from a first signature state to the third signature state. The altered signature state is used by the comparator which establishes a “3” in memory corresponding to the alphanumeric character closest to the user altered contact point and in accordance with the altered contact point's meaning in memory. The comparator instructs the reader to update the second user input display 39b to show the second user input 67b. A second altered RFID reader signal to display 38b is sent by the reader to update the display to communicate visually the user input which has been received and interpreted. The user is able to see the number “13” on the display and therefore knows her input has been properly received by the reader and interpreted by the comparator process in conjunction with values stored in memory. Thus an altered wireless readable contact array 22a has captured via an altered adhere-able substrate 467b and communicated a user's keyed input via wireless and batteryless RFID.

The comparator, display and memory operating slightly different in FIG. 5 than in FIG. 4. The comparator in FIG. 5 is executing processes based upon a string of user inputs comprising both the “1” input of FIG. 4 and the “3” input of FIG. 5 which it interprets as a user string meaning “13” which the comparator stores in memory as a string and instructs the reader to send to the display as a string such that the updated display 39b shows the user's input string of two characters not just an individual character. The comparator also stores the string in memory as the second user input in memory 48b and the comparator uses the user input string to control a process through the channel changing TV tuner 43b which changes the television channel to channel 13. For the purposes of this application, the meaning of a string is a sequence of user key strokes on a keypad or a keyboard such as is described in FIG. 5. Alternately a string may mean a sequence of inputs caused by a user such as with the controlling of a mouse in FIG. 8 and a joystick in FIG. 10.

Note that in FIG. 5 the first contact point is not longer closed as was the case in FIG. 4, it only remained closed while the user's finger was in contact with it.

FIG. 6 is a flowchart describing a range of process steps for creation and user operation of contact array based user interfaces for inputting data and wirelessly controlling systems and processes using an RFID transponder. In a fabrication step 22, the contact array is produced and integrated with an RFID (or equivalent such as a SAW) transponder such that the status of each contact can be reported wirelessly according to a predetermined protocol in a wirelessly emitted signature. A first contact status having a first signature in a first state a second contact status having a second signature in a first state, and a third contact status having a third signature in a first state. Each contact state and corresponding signature being alterable according to the discretion of a user. In a user directed process, the output signature being alterable with regard to one or more attributes such as; readability (can it be read at all), intensity, frequency, wavelength, or modulation pattern. Each contact's first state may be “closed” in a state 1 “on” signature 54 step. Alternately each contact's first state may be “open” in a state 1 “off” signature 55. A contacts positioned in proximate relationships to graphic symbols 56 step is utilized when a user's inputs are to be associated with specific indicia symbols or alphanumeric characters a user desires to input. In such applications, specific graphical or alphanumeric indicia generally appear in close proximity to contacts that are used when a user elects to input meanings associated the specific indicia as data or to control systems or processes. As in the prior art, the present invention embodies devices such as TV remotes, and computer keyboards that enable users to input data associated with specific buttons or key selections except these button or key positions are associated with contacts that are read out serially according to RFID protocols or processes via a transponder which is the vehicle for communicating the user's selections of respective keys or buttons both wirelessly and batterylessly. Where the conductivity of a user's skin moisture such as a finger is used to complete a circuit, no physical key or button is required, just the electrically exposed contacts and the indicia in predetermined proximity to the contacts. Alternately, buttons known in the prior art including those of FIGS. 8, 11a, and 11b can be used to open or close contact states. Whether fingers or other means are utilized to open and close contacts, a store map of contact positions or associated signatures or represented symbols in memory 57 step is required to ensure that the contact associated with a specific indicia or alphanumeric symbol is stored in memory such that when a reader senses a change in that specific contact's signature (or doesn't sense that contact's signature as the case may be) a comparator assigns the proper input meaning from memory that the user intended. Also the store map of contact positions or associated signatures or represented symbols in memory 57 step may involve creating an actual contact position map in memory which is not associated with any specific characters but is useful to track the sequence of contact state changes and corresponding signature changes for application in positioning a curser on a computer for example according to the mouse of FIG. 8, and the pad of FIGS. 11a and 11b. This is consistent with a store meaning of respective signatures, states, combinations, sequences in memory 58 where steps are taken to store in a memory a list of alphanumeric characters or other indicia each associated with a signature state change which in turn corresponds with a respective contact state change, also stored in memory can be a meaning assigned to a combination or sequence of signature state changes associated with a respective set of contacts whereby the states of the set of contacts are changed in a combination or sequence defined in memory and assigned meaning in memory, an example of where this is useful is in the use of mouse movements in FIG. 8 to control the position of a curser as is very common in computers.

A reader or sensor senses signatures, states, combinations, sequences 59 is the ongoing process whereby a reader establishes a dialog with a transponder associated with the contact array and senses a sequence of signatures or a serial dialog from the transponder and detects changes associated with contact state changes caused by a user interacting with the contact array and causing respective contacts to switch between a first state and a second state as a means to input data, control systems, and control processes. The reader interfaces with the comparator such as in FIGS. 3, 4, and 5 which compares the signature changes to those that were stored in memory in steps such as the store map of contact positions or associated signatures or represented symbols in memory 57 and the store meaning of respective signatures, states, combinations, sequences in memory 58 thus the comparator (or computer processing unit) assigns meaning from memory to the input it receives from the reader, and puts user input data in memory, information in the memory to determine what signature changes are present and to assign meaning to the changes in signatures. A user alters signature state 60 is the step as has been discussed above in this and preceding Figures whereby a user can input data or commands that control systems and processes by changing select contact states which in turn alters a transponder output signature or patterns to those predetermined to have assigned meanings in memory. It should be noted that in addition to animate input described herein, inanimate processes can be monitored and controlled using transponder arrays described herein and in the prior art of the present application referenced herein and incorporated by reference. This application is a Continuation In Part of U.S. patent application Ser. No. 11/224,163 filed Sep. 12, 2005 and of U.S. Provisional Patent Application No. 60/759,084 filed Dec. 12, 2005 which contains descriptions relevant to this application which are not repeated to avoid redundancy but are incorporated herein by reference. A sensor senses altered signature state or no signature 61 step suggests that the user has made an input selection. Similarly to FIGS. 3, 4, and 5, a lack of signature or altered signature state triggers corresponding values or instructions from memory 62 whereby the comparator assigns meaning by using values in memory to describe the meaning of the user's selection or non-selection as the case may be. In a comparator step 63, the comparator is used to determine changed signatures, states, combinations, and sequences and to access their meaning from memory to create user input data, control processes, and control systems that may interface with a wide range of devices according to user input. The user input devices including such things as a touch screen user contact array on transparent substrate 64 for placing in front of an electronic display, and whereby the meaning of a user input through a specific contact state change may be assigned a plurality of meanings in memory according to what image is displayed on an electronic display this touch screen user input device, process and application being discussed in prior patent applications reference herein. A surface adhere-able sticker 467c is a type of contact array user input device that can be adhered nearly anywhere one desires to have a user input device such as a game interface 66, the other devices referenced in this application, and many other devices not specifically referenced herein. Steps in FIG. 4 having applications to the processes and systems described throughout this application. NOTE in the flow charts and diagrams of FIGS. 3, 4, 5, 6, 7, 9, and 10 that anything processed by the comparator can be output from the reader to a display to advise a user what their input is interpreted to mean, or to display information called up by the user, or to display information which indicates the status of a process initiated or controlled by the user's input. Example of the reader sending signals to control the image on a display associated with the user's input being discussed in FIGS. 3, 4, 5, 8, 9, 10 including displaying alphanumeric characters selected by a user on a wireless contact array and displaying the positioning of a curser on a computer display according to a user's movements sensed on a wireless contact array as in FIG. 8.

FIG. 7 illustrates a process flow chart comprising the steps that may comprise aspects of the present invention such as fabrication of a RFID enabled user alterable wireless batteryless contact array, its operation for capturing of user inputs, sending of altered RFID signatures, wirelessly interfacing with a reader which senses altered signature outputs, and converting sensed altered signatures, into data and computer instructions, and the displaying of user inputs or computer data in accordance with a user's instructions. The flow chart of FIG. 7 and the discussion thereof comprise the other Figures of this application and the other applications referenced herein. FIG. 7 depicts processes and steps that in a variety of combinations may each comprise the present invention.

A produce contact array substrate comprising a plurality of contacts and integrated with a wireless and batteryless RFID transponder or similar device (such as for example a SAW surface acoustic wave) RFID process 467d is first undertaken according to FIGS. 1, 2 and 12f and the prior applications referenced herein. A comparable process relating to the mouse of prior applications referenced herein would be the production of a contact array having suitable characteristics replacing the transponder array with a contact array to capture physical rotational movement and then the integration of it with an RFID device such as a tag or transponder. A comparable process relating to the joystick of FIG. 10 would be the production of a contact array having suitable characteristics to capture the tilting movements of a stick and then the integration of it with an RFID device such as a tag or transponder.

In the substrate fabrication process a create printed indicia step 401d may be undertaken. If undertaken, this step entails a printing of at least a first indicia character in proximity to a first contact and a second indicia character in proximity to a second contact wherein the first and second contact are separated by an insulating space. A substrate integration with signaling means for communicating contact status step 205 is undertaken and can comprise the integration of the contact array substrate with the transponder and the protocol language such as a serial readout already discussed herein. A contact status assigned meaning in memory step 205a comprises assigned a meaning in memory for a change in status of a specific contact from its first state to a second state as communicated by a wireless signature as discussed throughout this application and its precedents. Also, this step may comprise definition of a signature protocol and its association with meaning in memory. A storage in memory step 48c comprises making in memory an association of RFID signature changes with specific meanings in memory. Examples of meanings stored in memory include signature changes that comprise a meaning of a first indicia character and signature changes that comprise a meaning of a second indicia character, signature changes that comprise instructions in memory that are to be initiated, combinations of signature changes that comprise a meaning, sequences of signature changes that comprise a meaning, unique identifiers for each specific device capable of interfacing with a reader can be stored in memory, a map of a contact array can be stored in memory, and a first contact and first associated transponder's signature status may convey the open or closed status of first door, while a second contact and second associated transponder's signature status may convey the open or closed status of second door. Once the contact array is fabricated and meanings are assigned in memory, the device and associated components such as reader, processor, and memory can be operated by a user. An alter selected contact statuses step 53b comprises a user interaction with the contact array which changes one or more contact statues from their first state to their second state. Mechanisms for changing the states of contacts can comprise a human touch step 211, a mouse movement step 213, a keyboard keystrokes 221, a keyed in put 214, a writing step 223, another process 215 such as the opening or closing of a door for example. Each of these processes for changing the status of contacts can begin with contacts in the open state and comprise the step of changing them to a closed state 219. Alternately, each of these processes for changing the status of contacts can begin with contacts in the closed state and comprise the step of changing them to an open state 217. In any case, the user directed change in contact states causes a contact array substrate/transponder combination readout altered signature step 38c which may comprise a change in frequency 227, a change in detect-ability 229, a change in modulation pattern, or a change in intensity 233. A sensing step 30d comprises the use of a reader to iteratively sense the readout signature of the contact array substrate and associated RFID transponder. In the sensing step 30d, the reader receives from the transponder a first contact status signal, the reader receives from the transponder a second contact status signal, and the reader receives from the transponder a third contact status signal. Each status signal indicated the open or closed status of the respective contact. The reader sends a communication to the comparator comprising encoded status information about respective contacts which is subjected to a comparator step 49a where the sensed status of contacts is compared to the pre-assigned meanings of contact status or associated transponder signatures that were stored in memory in the storage in memory step 48c such that the signatures sent by the transponder and received by the reader are compared to signatures stored in memory and when a match between memory and signature(s) received is found by the comparator, that meaning from memory is assigned to the signature received by the reader. A providing reader step 30c is provided to provide the means to wirelessly sense the status of the contact array substrate in an iterative process. Signatures received during the sensing step 30d may be stored in a store sensed in memory step 48d and their meaning assigned by the comparator may also be stored in memory. Once the comparator assigns meaning to signatures received by the reader, an altered contact step 241 can be undertaken including an initiate altered contact process step 45a thus the user's input controls systems and processes. Once the comparator assigns meaning to signatures received by the reader, a detectible altered contact step 241 a can be undertaken including an initiate detectible signature process step 45b thus the user's input controls systems and processes. In embodiments where the sequence of changes in contacts are used for positioning information in computer co-ordinance such as is the case with a mouse, the comparator can plot the sensed contact changes to a map in memory in a plotting step 245. A store plotted map in memory step 48e can be undertaken to keep track of where the user is instructing the curser to be within the computer coordinate system. A conversion step 49a is undertaken by the comparator to convert plotted contacts to altered sequence patterns such as where a pencil writes on a substrate and is recognized as data as has been described in the prior applications referenced herein and of which this application is a continuation in part. In the conversion step 49a, signal changes sensed by the reader, compared to signals in memory, interpreted by the comparator, can be converted to indicia and including a recognize indicia step 49c. A stored recognized indicia in memory step 48f ensure that the user input is stored as accessible data for subsequent accessing of recognized indicia processes 255 such as a key word search step 259.

FIG. 8 illustrates an RFID transponder enabled wireless, battery-less contact array based substrate and mouse user input device for inputting data and controlling systems and processes. The components of a mouse can be readily adapted to the contact array technique taught above. A left click open contact 73 comprises an open contact that can be closed by the touch of a user and which is positioned on the left side of the upper surface of a mouse shaped substrate 52. When touched by a user, the left click open contact 73 is caused to change from a first contact state of open to a second contact state of closed. As previously taught herein, as the contact state changes states, a corresponding signature signal state changes which can be sensed by a reader and assigned meaning when compared to a memory by a comparator. The RFID reader can sense the change in state and according to instructions executed by the comparator and information stored in memory, assigns a left click value to the user's touch. Similarly, a right click open contact 74 comprises an open contact that can be closed by the touch of a user and which is positioned on the right side of the upper surface of the mouse shaped substrate 52. The right click contact operating similarly to the left click contact except the output signal signature it causes is distinguishable from that caused by the left click contact. The RFID reader can sense the change in signature state and according to instructions executed by the comparator and information stored in memory, assigns a right click value to the user's touch. A raised scroll structure is a rigid bump on top of the mouse shaped substrate 52 that is designed to resemble in shape and operation a scroll wheel but which doesn't actually move. As a user touches in sequence a plurality of contacts in succession including a first scroll contact 75 and then a second scroll contact 76, and thereby changes respective contact states from open to close, the RFID reader will read the succession of contact changes from first state signatures to second state signatures and the comparator will interpret them as a user scrolling down on a wirelessly connected computer screen and the computer will accordingly scroll down on the connected computer screen as the user directs. Software for controlling the curser in response to commands from a mouse being well known in the prior art and compatible with the art herein. The prior art of the present applicant also describing a rotating type means for capturing the positional input of a mouse that is compatible herewith and whereas in the prior application individual transponders comprise the contact points, in the present application, only a single transponder is used and a plurality of contact points connected to the single transponder are opened or closed as the mouse elements rotate. The mouse shaped substrate of the present invention however does not need such a rotating element since the position of the mouse is communicated through the opening and closing of contacts on a mouse pad substrate 467e as follows. The mouse pad contact array 467e is fabricated and integrated with an RFID transponder according to FIGS. 1, 2a, 2b, and 12f. A first mouse pad open contact point 407b, a second mouse pad open contact point 106b, and a third mouse pad open contact point 87 are a few of the many open contact points comprising the mouse pad contact array. In operation, the bottom side of the mouse shaped substrate 52 comprises an electrically conductive material that closes the contacts on the mouse pad contact array 467e that it comes into contact with. Thus the connected transponder emits a signal signature that describes the position of the mouse shaped substrate 52 upon the surface of the mouse pad contact array 467e. Thus the reader can sense a signal from the transponder in communication with the mouse pad contact array 467e which describes the position and movement of the mouse shaped substrate 52. As the user move the mouse shaped substrate, the reader senses a sequence of closed contacts as a succession of changes from first state signatures to second state signatures and this sensed information is interpreted by the comparator as a user command to move the curser across the computer screen from the left to the right for example. Software and logic for controlling a curser in response to a user's input into a touch pad being well known in the prior art and having application herein.

An alternate means for communicating right and left mouse buttons comprise the lower portion of FIG. 8. A first mechanical button 88, and a second mechanical button 89 are positioned in proximity to the mouse pad. A first contact in open first state 91 has an open circuit such that a connected transponder emits a first signature as previously described herein. When a user depresses the first mechanical button 88, its lower surface is brought into electrical communication with the first contact in first open state 91 such that its circuit is closed and it is transitioned into its second signature state comprising a difference that is emitted by the connected transponder, sensed by the reader, and assigned by the comparator a left click value which is stored in memory. A first mechanical spring 92 will cause the button to revert to its elevated state when the user no longer depresses it. A mechanical switch substrate 93 has the transponder affixed thereto and together with a mechanical button guide facing 97 contains the buttons. A second mechanical button 94 similarly operates as above for reporting the user's right clicks and a second mechanical spring 95 ensures the associated right click button will not remain depressed. A printed graphic on mechanical button 96 illustrates that alphanumeric information can be placed upon keys to operate similarly as a keyboard but using the under art described in the present application. The keyboard operating wireless not requiring batteries. The mechanical buttons can also be fashioned so as to be able to stay depressed if so desired.

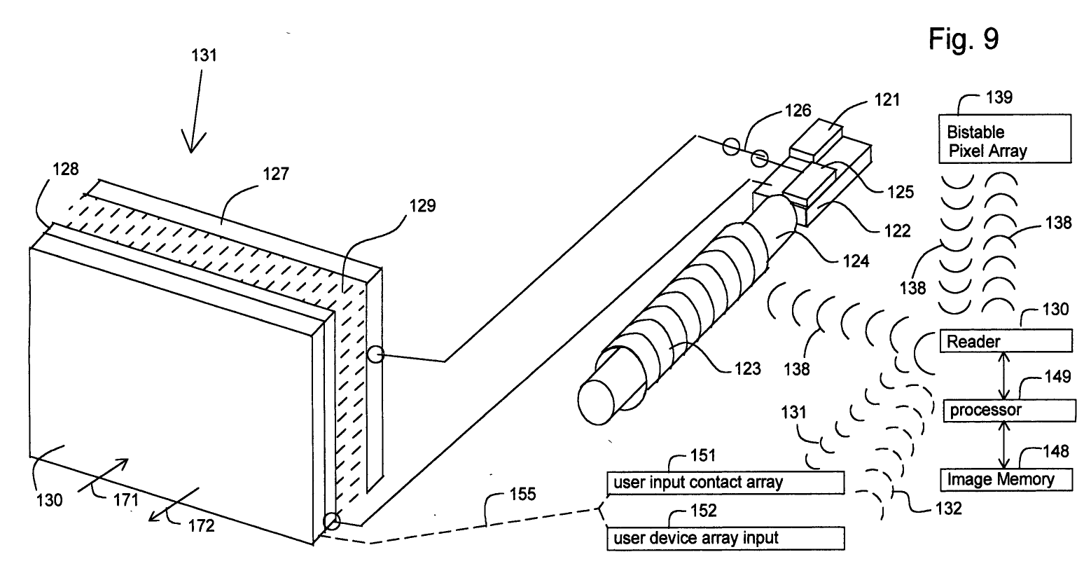

FIG. 9 illustrates an RFID controlled bistable display such as is also described in FIGS. 3, 4, 5, 7, 8, and 10. A transponder chip 121 is manufactured, configured, and positioned according to the prior art on a printed circuit board 122 such that it derives power from a coil 123 having a core 124. As is common in transponders of the prior art, a capacitor 125 is provided that stores power collected through induction by the coil 123. The emission of energy by the capacitor 125 being controlled, similarly to the prior art, by the transponder chip 121 via an “off” switch 126. The “off” switch is capable of be turned on and of in rapid succession so it can address electricity to individual pixels in a bistable pixel array 139 including an individual pixel 131. Many prior art methods are known for addressing electrical power to bistable displays comprising arrays of pixels and timing mechanisms for directing electrical charges to individual pixels in an iterative process. Suppliers of suitable bi-stable displays with internal addressing mechanisms that are suitable for powering by an RFID transponder include E Ink, Kodak, SiPix, NTERN, ZBD, Nemoptic, Kent Displays, and others. The present invention involves using an RFID transponder to control the image on a bistable display and whereby that image is representative of input that a user keyed into a wireless RFID input device or mouse, our, joy stick or other devices as described herein. Alternately, the image on the display can be representative of a computer process initiated or controlled by the user. whereby that image is representative of input that a user keyed into a wireless RFID input device or mouse, our, joy stick or other devices as described herein.

Through the display addressing mechanism, the “off” switch 126 is in electrical communication with an “off” reflective electrode 127. The “off” reflective electrode 127 is common in the prior art of reflective liquid crystal displays in that it has suitable electrical properties to communicate an electric current or field, it also has polarized optical properties on its front surface to reflect properly directed ambient light and an absorptive layer on its rear surface to absorb improperly directed light. Also in communication with the printed circuit board 122 is a transparent electrode 128 being transmnissive to visible light and able to communicate an electric field such transparent electrodes being common in the prior art for use with liquid crystal cells. When the “off” switch 126 is in the “off” state, a first state liquid crystal 129 is configured in a first light directing state so as to direct light to be absorbed by the rear surface of the “off” reflective electrode such that the cell can be observed to be in a visibly darker state which absorbs an ambient light 171 which is polarized, directed, and absorbed by the pixel (and is polarized, directed, and reflected by the pixel as reflected light 172). At the pixel level, the reflected light can be modulated between lighter and darker states according to the state of the “off” switch according to instructions received by the transponder wirelessly through RFID. Further description by the present applicant being in U.S. application Ser. No. 11/376,799 which is incorporated herein by reference. As is common in the art of liquid crystals, a polarizing film 130 is provided to ensure that light is properly directed by the liquid crystal when passing there through. The elements described heretofore and further described herein comprising an individual pixel and control 131 as part of a controlled display according to the present invention. The LC Pixel cell being a display element that can transition between a first visible state and a second visible state, the two states being visibly distinguishable from one another by an observer. The control means being an RFID transponder that controls when energy is to be applied to the LC Crystal to cause it to transition between a first visible state and a second visible state or to maintain a first visible state or to maintain a second visible state. The RFID transponder control means is in wireless communication with a reader 140 which is common to the prior art of RFID communication systems with respect to fabrication and operation. The pixel and control 131 comprising the means to receive a signal from an RFID reader, store energy from an RFID reader, and apply the energy from the RFID reader to pixels in a bistable display at the direction of the RFID reader or alternately to apply energy from a secondary power source according. According to the prior art of RFID systems, the reader 140 is in communication with a processor 142 and a memory 143 which together operate to process incoming signals and selectively send outgoing signals such as those representing images from the memory through the processor through the reader to a bistable display such as the reflective liquid crystal array display depicted in FIG. 9. The reflective liquid crystal array with of FIG. 9 comprising a plurality of pixels with associated controls and wherein a first reader output 141 comprises a wireless signal which is communicated to each of the pixels via a transponder such that each respective pixel element is caused to either take a first “on” state or a second “off” such that the plurality of pixels form a character or image conforming to that which is stored in memory, processed by the processor, and sent wirelessly by the reader. The signal from the reader can comprise a series of individual communications to respective individual pixels in series with an analog instruction being received by the transponder which is caused to accordingly either open or close the switch to control power to an array of associated liquid crystal contacts such that each individual LC pixel will be controlled to be either visibly in a first darker “off” state or a second brighter “on” state. The first reader output 141 also comprises an RFID signal which is used to power the transponder, and the plurality of bistable pixels, and to communicate with other RFID elements as is common in the prior art. The first reader output 141 comprises signals to the plurality of respective transponders to each turn “on” or “off” a respective individual pixel in accordance with the image that the reader is communicating from the memory. The image formed by the display can be an alphanumeric character such as is common on calculator displays for displaying numbers entered by the user and calculated by the calculator's processor. Additionally, the image formed by the display can be a graphic image such as is common on cell phones. The art described herein being suitable for a wide range of displays and applications. Where user input is captured via a wireless and batteryless device using RFID, a reader senses the user input, a system connected to the reader processes the user input and sends a signal corresponding to the user's input back to the reader the reader sends a signal to a transponder that is used to control a display to display information relating to the user's input.

Both a user input contact array 151 which accepts a users keyed input and which is RFID readable and convertible to data and an alternate user contact array 52 such as a mouse, touch pad, or joystick according to inventions described herein and additional inventions by the present inventor referenced throughout the present application can be integrated with the RFID controlled display described herein such that the user input device array can be operated by a user to be caused to emit via RFID a user wireless input 153 as a wireless communication with the reader. Based upon the user's input, the reader can wirelessly communicate back to the display either an image of what the user input or an image resulting from a calculation based upon what the user input. In a display integration 155 step, the display can be physically integrated into the user input device such that as a user inputs a character into the device in the referenced prior Patent Applications, that character can be sensed by the reader, interpreted and sent back to the display, such that, in concurrent time or nearly concurrently, the user can see on the display the characters that the reader has interpreted as his input into the device. Thus the display integrated with the user input device gives the user the opportunity to ensure that his input is being correctly received and interpreted by the reader in cooperation with the processor and the memory. In this scenario, the user device with integrated display will comprise a very cheap, battery-less, wireless device that accepts user input and displays the user input but which has no onboard means of associating the user's input with the displayed input since that capability is all on the reader side of the system and communicated wirelessly to and from the reader respectively. Additionally, in a calculator application for example, that is illustrative of one application among many, the user inputs alphanumeric characters or numbers and operational commands, the reader wirelessly senses the user's input which is processed by the processor to calculate an answer which is then wirelessly sent to the display by the reader.

Together, the elements such as transponder chip 121, printed circuit board 122, coil 123, and capacitor 125 comprise an RFID transponder of the prior art, which can be constructed similarly to a Texas Systems transponder described on page 15 of RFID Handbook by Finkenzeller Published in 2003 by Wiley, and these elements comprise the transponder and control portion of the bistable display of FIG. 9.

Together the “off” reflective electrode 127. Transparent electrode 128, first state liquid crystal 129, and polarizing film 130 comprise a display pixel that can transition between a first visible state such as the darker state and a second visible state such as the brighter which can be fabricated and operated according to the prior art such as that described on page 14 of Reflective Liquid Crystal Displays by Wu and Yang published in 2001 by Wiley. Such individual pixels often being combined with arrays of a plurality of pixels to form a display wherein information displayed thereon can be varied. The present invention providing a variable pixel that can be wirelessly controlled by an associated pixel level transponder/controller.

FIG. 10 illustrates an RFID wireless and batteryless contact array joystick user input device of the present invention. A joystick contact array 467f comprises a substrate with contacts thereon including a first contact 407c and a second contact 106c. Passing though the joystick contact array is a joystick handle 107 which is suitable for a user to hold and to move in a first direction 109 and is a second direction 108. A movable contact circuit 403a carries an electrical current which when not actuated by a user does not complete a circuit and when actuated by a user completes at least one of a plurality of electrical circuits. In operation, when a user moves the joystick handle in the first direction a circuit is completed when the first contact becomes electrically in contact with the movable contact circuit. Similarly, when a user moves the joystick handle in the second direction a circuit is completed when the second contact becomes electrically in contact with the movable contact circuit. The contacts are integrated with the elements of FIGS. 1, 2a, and 2b to by readable wirelessly using RFID as discussed throughout this application. Thus the joystick of Figure provides a means for a user to interact with remote computer wirelessly and without batteries.

FIG. 11a illustrates a magnetically actuated contact array substrate in default open contact state. A magnetic actuated substrate 467g is fabricated and operated identically to descriptions under 1, 2a, 2b, and ensuing figures with the exception that user inputs are captured by a magnetic stylus 88a which when placed in close proximity to a first number 101a actuates a first ferrous block 53c to be actuated into electrical communication with a first upper contact point 407c, and a second upper contact point 106c and there by completing an electrical circuit there between. The completion of this electrical circuit changes the state of an RFID signature which is sensed by a reader and interpreted by a connected processor as a user input of “3”. Note that the other upper contact points in the substrate array are by default in an open circuit state including a third upper contact 503 and a fourth upper contact 505 which remain electrically isolated from one another when the second ferrous block 501 is on the bottom of a cell that contains it. Thus a second number “4” 105a is not interpreted as being selected by the user. This art of FIG. 1a being an alternate mechanism for a user to input data or computer instructions through wireless and batteryless RFID readable devices. Shown in cutaway view but in practice many more cells can be similarly arrayed.

FIG. 11b illustrates a magnetically actuated contact array substrate in default closed contact state. An alternate magnetic actuated substrate 467h is fabricated and operated identically to descriptions under 1, 2a, 2b, and ensuing figures with the exception that user inputs are captured by a magnetic stylus 88a which when placed in close proximity to a first number 101a actuates a first ferrous block 53d to be actuated out of electrical communication with a first lower contact point 407d, and a second upper contact point 106d and thereby rendering an electrical circuit there between as incomplete or open. The opening of this electrical circuit changes the state of an RFID signature which is sensed by a reader and interpreted by a connected processor as a user input of “3”. Note that the other lower contacts points in the substrate array are by default in a closed circuit state including that are in electrical communication with a the second ferrous block 501 which is by default on the bottom of a cell that contains it. Thus a second number “4” 105a is not interpreted as being selected by the user. This art of FIG. 11b being an alternate mechanism for a user to input data or computer instructions through wireless and batteryless RFID readable devices.

FIGS. 12a through 12f illustrate steps in a contact array substrate printing fabrication process. FIG. 12a depicts a paper substrate 401e having an upper surface and a bottom surface. In this step, a paper substrate is provided. Suitable equivalent substrates can be made from many materials such as plastic for example. FIG. 12b depicts a step of printing alphanumeric characters on the upper surface of the paper substrate including a first printed character 601 and a second printed character 603. In practice, many characters can similarly be printed and may be printed in standard arrangements such as the positions of keys on a standard computer keyboard for example. Characters can be printed using electrically conductive or electrically insulating ink. FIG. 12c depicts the printing or deposition of a first conducting row 605 onto the upper surface of the paper substrate and over at least a portion of some of the printed characters or in close proximity to the printed characters. Processes for printing and otherwise depositing conductive material are well known in the prior art. FIG. 12d depicts a second layer printing or depositing a first insulating column 607 which also is deposited on the first printed character and a second insulating column 609 which also is deposited on the second character. Many such processes and materials for printing and depositing insulating layers are known in the prior art. FIG. 12e depicts the last fabrication step where conductive columns are printed or deposited on top of respective insulated columns including a first conductive column atop insulator 611 and a second first conductive column atop insulator 613. The printing and depositing of conductive materials on top of insulators being well known in the prior art. The three layers of FIGS. 12c, 12d, and 12e comprise a plurality of open contacts in array that can be integrated into the flip-flops and shift register of FIG. 1 and integrated with the RFID transponders in FIGS. 2a and 2b with the resulting integrated contact array substrate being operational according to the descriptions in the present application and of the applications referenced herein. The insulating columns prevent direct electrical communication between the conductive rows and the conductive columns. Accordingly a user's finger 53e or another means can be used to close a circuit between a column and a row to capture user input of alphanumeric characters such as the number “4” which has been selected by a user in FIG. 12f. Similarly, the substrate can be fabricated with no alphanumeric characters and be used like a touch pad to control a computer including a transparent touch pad for use as a user input device in front of a computer display.

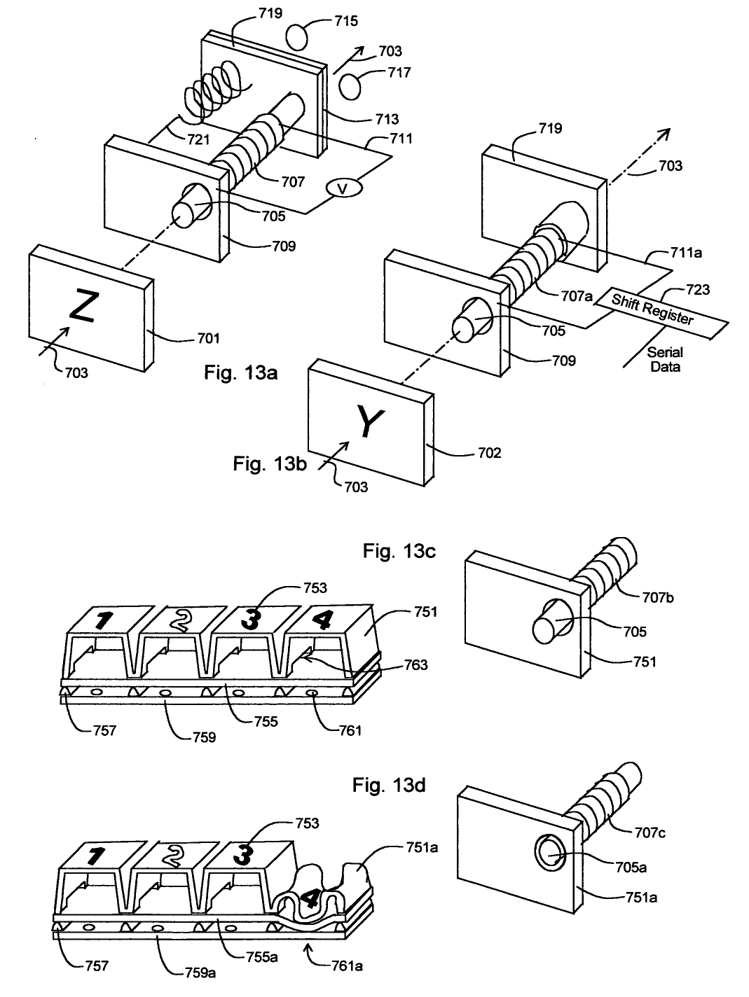

FIG. 13a illustrates architecture and process for generating a current each time a user depresses a key. A “Z” key 701 is a plastic substrate with a letter “Z” printed thereon and which is affixed to a bar magnet 705. The bar magnet passing through a housing 709 such that the bar magnet can move in an inward 703 direction when a user depresses the “Z” key and an opposite outward direction when the user releases the “Z” key. Affixed to the bottom surface of the housing is an induction coil 707 which is in electrical communication with a key circuit 711 such that when the bar magnetic moves in and out of the induction coil a current is generated in the key circuit. The key circuit can tie into electrical circuits of the substrates of FIGS. 1, 2a, and 2b as an alternate power source means to power RFID and computational processes and may include a capacitor to store electrical charges induced by the user's key stroke and a rectifier to transform user generated AC electricity to DC electricity. When the user depresses the “Z” key, a base plate 719 including an electrically conductive side 713 is brought into electrical communication with a first input contact 715 and a second input contact 717 thereby closing a circuit which as discussed in prior Figures herein changes the state of an RFID output signature which can be sensed by a reader and translated into user input by a remote computer in communication with the reader. When the user releases the “Z” key, a key spring 721 which is affixed on one end to the bar magnet and on the other end to the base plate, causes the bar magnet and “Z” key to be pushed back to their original positions. FIG. 13a illustrates a process for capturing and converting a user's mechanical energy from key strokes into electrical current which in turn is used to power a circuit. The circuit being that used to augment the power of a passive RFID key input device of the present invention. In addition to providing electrical energy, the key stroke concurrently changes an input circuit from a first state to a second state which as discussed throughout this application is a means to modulate an RFID signal as a means for communicating a user's input. While FIG. 13a shows a single key, in practice whole keyboards of similar keys are used by a user to key in data and control systems. Each having a means to convert the key stroke's mechanical energy into electrical energy similar to the key depicted and discussed in FIG. 13a. It will be understood by those skilled in the art that equivalents such as a piezoelectric cell capable of converting mechanical energy to electrical energy can be substituted for the bar magnetic and induction coil depicted. Systems that receive mechanical energy from a user and convert it to electrical energy are known in the prior art including hand cranked radios and sneakers that convert walking energy into electricity to power electrical apparatuses.

FIG. 13b is an alternate current generator at the key level. FIG. 13b illustrating an improvement over FIG. 13a wherein the electricity created by a user's key stroke is sensed directly by a direct shift register 723. An alternate key circuit 711a is similar to the key circuit of FIG. 13a but the electrical current it generates is directly the user input signal which is used by the direct shift register 723. By contrast while one electrical process is depicted in FIG. 13b, two electrical processes are described in FIG. 13a including the conversion of mechanical energy to electrical energy and the completion of a circuit by the electrically conductive side 713. In practice, the direct shift register 723 plugs into the processes of this application similarly to the shift register of FIG. 1 and of FIG. 2b such that multiple inputs from multiple keys come into the shift register which can output a serial data stream suitable for communicating via RFID protocols and modulation processes described herein. The energy of a user's key stroke is converted to an electrical energy which is sensed by the shift register and used to modulate a serial data stream indicative of the status of keys on the key board. In some embodiments, the induction coil 707 of FIG. 13a can be replaced by a coil spring/induction coil 707a which in addition to producing an electric charge as the bar magnet passes there through also operates as a spring to return the key to its original position when not being depressed by a user. The coil spring/induction coil 707a being affixed to the housing 709 and the base plate 719 and the bar magnetic 705 being affixed to the housing 709 but able to move inward and outward relative to the base plate such that the bar magnet moves relative to the coil spring/induction coil.

FIG. 13c illustrates a key pad architecture where multiple keys share a single key stroke based current generating means in a non-depressed state. A compressible key array 751 comprises a rubber or plastic molded array of keys as are common in the prior art. Printed upon each compressible key is an alphanumeric symbol 753. The compressible key array 751 is affixed to the surface of a touch type input device common in the prior art and available from White Electronics and others. The touch type input device comprising a stretchable membrane 755, a rigid substrate 759, and an array of separators similar to a first separator 757. The stretchable membrane comprising a first half of an open circuit and the rigid substrate comprising an array of contacts each comprising the second half of an open circuit. In use, a user depressing the stretchable membrane to contact the rigid substrate closes a circuit to create a user input. Between the stretchable membrane 755 and each key in the compressible key array 751 are a series of cavities that are filled with a fluid. In operation such as in FIG. 13d, when pressure is exerted upon a key, fluid can flow through fluid channels such as a first fluid channel 763. When not compressed by a user, the fluid pressure under the keys is neutral and a multiple key mechanical induction coil 707b is in a first position. When not compressed by a user, the stretchable member is prevented from contacting the rigid substrate by the array of separators. In operation as in FIG. 13b, when a user compresses a key, the stretchable membrane is caused to make contact with the rigid substrate 759 and thereby completing a circuit. Since the user is not compressing a key in FIG. 13c, no contacts are closed including for example rigid substrate contact 761 which remains open. Note that the fluid pressure of the compressible key array is in mechanical communication with the bar magnet so that as if FIG. 13d, when pressure is applied to a compressible key, the bar magnetic is caused to move within the induction coil to a second position. The elasticity of the deformable keys and a spring connected to the bar magnet can be used to restore the key to its shape in FIG. 13c and the bar magnetic to its position. Thus when being operated by a user the compressible key array can transition back and forth between the shape of FIG. 13c and that of FIG. 13d to capture a user's input and concurrently provide electrical current to power an otherwise passive RFID process.

FIG. 13d is the key pad of FIG. 13c with one key in the depressed state. A compressed key 751a is created when a user depresses a key upon the compressible key array of FIG. 13c. The mechanical energy a user applies to the compressible key deforms its shape which causes underlying fluid to be compressed and transfer its compression energy to an actuated bar magnetic 705a which mechanically moves thereby creating a current in the corporate induction coil 707c. Note that in fabrication the fluid cavities beneath the compressible key array are in fluid communication but not electrical communication with the actuated bar magnet and the fluid is otherwise contained in a closed system such that the only direction the fluid can flow is by actuating the actuated bar magnetic. Fluid displaced by any key on the compressible key array will similarly actuate the same bar magnetic. Thus as a user works a keyboard, the bar magnetic is caused to move in and out of the corporate coil to create a current. Additionally, when the user compresses a key, the stretchable membrane becomes a stretched membrane 755a and it is caused to become in electrical communication with a closed circuit rigid substrate 761a to log the user's key input as a “4” which is used to modulate an RFID output signature as described throughout this application. In FIGS. 13a through 13d, a capacitor, battery or other means may be provided to store electrical energy induced by the coil, a rectifier may be provided to transform an AC current to DC as appropriate, and equivalent means for converting mechanical energy from key strokes into electrical energy may be substituted including for example a piezoelectric cell.

Operation of the Invention

Operation of the invention has been discussed under the above heading and is not repeated here to avoid redundancy.

Conclusion, Ramifications, and Scope

Thus the reader will see that the Contact Arrays and Processes for Wireless Batteryless User Input of this invention provides a novel unanticipated, highly functional and reliable means for employing RFID techniques in an RFID passive tag or transponder that comprises an array of contacts or switches that can be used to capture as data a wide range of user inputs which in turn can be used to drive an unlimited variety of processes.

While the above description describes many specifications, these should not be construed as limitations on the scope of the invention, but rather as an exemplification of a preferred embodiment thereof. Many other variations are possible for example:

The description herein illustrates the invention in a passive RFID tag or transponder, but it is understood to also be useful in active RFID tag or transponder systems.

A few applications are described herein but it should be understood that the applications of the present invention are virtually limitless.

Each RFID transponder may include a unique identifier aspect to their RFID readable signature.

Audible or inaudible sound waves can be substituted for electromagnetic radiation energy as the medium to both excite a remote transponder and to be sensed by the transponder and transceiver. For example the RFID based systems described herein can be replaced by a SAW or alternate systems.

The above description in most instances starts with contacts in an open state but it is understood that the contacts may start in a closed state and a user's input can be captured when transitioned to an open state.

A user's finger and a mechanical device are each shown as the means that enables a user to alter the signature of a RFID transponder. It will be understood that any means that has the ability to alter the properties of a contact state or circuit can be substituted for the user's finger or the mechanical switch described above.

The specifications describe a user interface for communicating information via RFID but it is understood that the devices and processes described can collect data from other processes that are not directly user inputs. For example the contact array of FIG. 8 can be used as a wireless passive position transducer where the mouse is replaced by a physical structure that is subject to movement which one would like to track wirelessly and passively. Thus elements of each Figure have applications for communicating status of conditions other than user inputs.

What is claimed:

1. A process for capturing user input comprising a passive device comprising a first contact and a second contact
and wherein a user can input data by transitioning the first contact between a first state and a second state
and wherein the user can input data by transitioning the second contact between a first state and a second state
And a memory is provided wherein the transition of the first contact represents a first alphanumeric character which is stored in the memory and wherein the transition of the second contact represents a second alphanumeric character which is stored in the memory,
And wherein a wireless process is used to communicate the user's input between the said passive device and the said memory.
